(19) United States
(12) Patent Application Publication
(10) Pub. No.: US 2004/0048147 A1
(43) Pub. Date: Mar. 11, 2004

(54) Rechargeable battery and manufacturing method thereof

(75) Inventors: Yoshiyuki Muraoka, Kamakura-shi (JP); Masaharu Miyahisa, Fujisawa-shi (JP); Ichiro Takeuchi, Yokohama-shi (JP); Yoichiro Tsuji, Osaka (JP)

Correspondence Address: GREENBLUM & BERNSTEIN, P.L.C., 1950 ROLAND CLARKE PLACE, RESTON, VA, 20191, US

(73) Assignee: Matsusjota Electric Industrial Co., Ltd, Osaka (JP)

(21) Appl. No.: 10/654,881

(22) Filed: Sep. 5, 2003

(30) Foreign Application Priority Data
Sep. 10, 2002 (JP) 2002-263461

(51) Int. Cl. H01M 10/40; H01M 4/80; H01M 2/26

(52) U.S. Cl. 429/94; 429/211; 429/235; 29/623.5; 29/623.4; 29/623.2

(57) ABSTRACT

A rechargeable battery uses metal foil for a substrate of at least one of positive and negative electrodes. The electrode includes a strip-like conductive portion formed of a bared edge portion of the substrate at one end along the winding direction, to which a current collector is welded. A porous metal layer is formed at least on one side of the strip-like conductive portion so as to prevent buckling or breakage of the substrate, or separation of weld joints.

The present disclosure relates to subject matter contained in priority Japanese Patent Application No. 2002-263461, filed on Sep. 10, 2002, the contents of which is herein expressly incorporated by reference in its entirety.

### BACKGROUND OF THE INVENTION

1. Field of the Invention

The present invention relates to an alkaline rechargeable battery such as nickel metal hydride batteries or nickel cadmium batteries, and a manufacturing method of the battery.

2. Description of Related Art

The positive electrode of alkaline rechargeable batteries that consists of a foamed nickel plate having a three-dimensional porosity rate of about 95% and spherical nickel hydroxide particles carried on this plate is suited to construct a high capacity alkaline rechargeable battery and has widely been used. The negative electrode for alkaline rechargeable batteries, on the other hand, generally consists of a punched metal plate having a thickness of about 60 μm and active material layers applied on the plate.

While rechargeable batteries that are used as the drive power source of electrical equipment such as electric tool need to have higher output to withstand high voltage and high discharge in accordance with the high power output of the equipment, the demand for lower cost is high. The foamed nickel plate used for the positive electrode is considerably expensive because it is fabricated through complex process steps wherein urethane foam that forms the core is nickel-plated, and then removed by calcination to obtain porous foam.

Battery output can be increased by improving the structure of the battery components: For example, the metal substrate may be made thinner and longer so as to increase the amount of active material applied thereon. Or, a tabless collector that allows current to be collected evenly from the entire electrodes may be employed, in which current collectors are welded to strip-like conductive, bared edge portions of the metal substrates of the electrodes, so that the battery will have excellent high-rate discharge characteristics.

Two-dimensional metal substrate materials such as punched metal or expanded metal are inexpensive as compared to the foamed nickel plate because they are generally fabricated by a mechanical punching method, and they can be made thinner to increase the amount of active material on the electrodes for higher battery capacity. Another low-cost metal substrate material shown, for example, in Japanese Patent Laid-Open Publication No. 2002-15741, has a three-dimensional structure: the metal sheet is formed with bulged strips alternately protruded on the front and back of the sheet and arranged in parallel rows. Furthermore, metal foil has been used in recent years to make the electrodes even thinner for a further increase in the battery capacity. For example, an alkaline rechargeable battery that uses very thin metal foil as the substrate for the positive electrode has been developed.

However, because the electrode using such thin metal foil as the substrate is lower in strength, sufficient weld strength cannot be achieved when welding current collectors to the strip-like conductive portions of the metal substrates by resistance welding. In the resistance welding, the current collectors need to be tightly pressed against the strip-like conductive portions. If sufficient pressure is not applied because of the low strength in the metal foil conductive portions, the welding is not properly achieved because of an increased electrical resistance between the current collectors and the strip-like conductive portions. When the rechargeable battery is subjected to a large impact as in a falling accident or the like, the weld joints between the current collectors and the strip-like conductive portions may be separated or the metal substrate may be cut, as a result of which the internal resistance will rise, or, a short circuit may be formed resulting from buckling of the weak strip-like conductive portions.

In light of this problem, metal substrates made of three-dimensional porous metal have been used in some rechargeable batteries so that the strip-like conductive portions of the electrodes formed of bared edge portions of the metal substrates, to which metal plates are welded, have higher strength (see Japanese Patent Laid-Open Publication No. 2000-21384, for example). In this structure, however, the interface between the strip-like conductive portions and the active material layers and the interface between the metal plates and the active material layers have low strength, because of which buckling can easily occur in the interface between the active material layers and the strip-like conductive portions when pressure is applied to the current collectors during the resistance welding. The interface is also easily cut when the rechargeable battery is subjected to an impact as in a falling accident. Furthermore, welding metal plates to very thin metal substrates such as metal foil is very difficult in practice; the metal substrates can easily deform because of sparks or heat during the welding. Such defect may well cause misalignment between the positive and negative electrodes when winding them with a separator interposed therebetween, or short circuits across the opposite polarity electrodes.

Japanese Patent Laid-Open Publication No. 2000-323117 teaches a rechargeable battery in which the strip-like conductive portions of thin metal substrates are bent at right angles toward the center of the wound electrode assembly so that the parts of the strip-like conductive portions on the outer peripheral side are laid over the parts on the inner peripheral side. The strip-like conductive portions that are bent are then flattened by applying pressure, and the current collectors are welded on the upper face of the flattened surface.

The high-rate discharge characteristics can be improved with such a structure because of even current distribution from the electrodes to the external terminals (sealing member or battery case), but the battery is still susceptible to impacts in a falling accident or the like because disconnection or buckling of the metal substrates is not completely prevented. What is worse, the welding of the current collectors on the strip-like conductive portions that have been bent can only be achieved by laser welding which does not involve application of pressure, because the pressure applied during the welding as in resistance welding will cause breakage of neighboring active material layers, which may lead to short circuits. The productivity is thereby lowered, and the running cost will be high, which is contrary to the aforementioned demands for higher output and lower costs.

### SUMMARY OF THE INVENTION

In light of the problems encountered in the prior art, it is an object of the present invention to provide a high output, low cost rechargeable battery having excellent shock resistance and free of buckling or disconnection of metal substrates or separation of weld joints, and a method for manufacturing this battery with good productivity.

To achieve the above object, the present invention provides a rechargeable battery, including:

a wound assembly of a positive electrode, a negative electrode, and a separator interposed therebetween, accommodated in a case together with electrolyte, the positive and negative electrodes being respectively formed of a metal substrate and an active material layer coated thereon and including a strip-like conductive portion at one end along a direction in which they are wound, the conductive portion being formed of a bared edge portion of the metal substrate, and current collectors being respectively welded to the conductive portions of the electrodes. The metal substrate of at least one of the positive electrode and negative electrode is made of metal foil, and the strip-like conductive portion of one of the positive and negative electrodes that uses metal foil is formed with a porous metal layer at least on one side thereof.

This rechargeable battery uses thin metal foil for the metal substrate of at least one of the positive and negative electrodes, whereby the electrode is made longer and carries more active material, to increase the battery capacity. The current collectors welded to the strip-like conductive portions are a tabless type, whereby the high-rate discharge characteristics of the battery are excellent and the output can be increased. Because the two-dimensional metal foil for the substrate is more inexpensive than conventional foamed nickel plates, a cost reduction is achieved.

The strip-like conductive portions made of the thin metal substrate are reinforced by the porous metal layers to have sufficient strength. The porous metal layer is readily formed by diffusion welding or other suitable means without presenting the problems encountered in the conventional welding of metal thin plates to the strip-like conductive portions. Thus, pressure can be applied sufficiently when welding the current collectors to the strip-like conductive portions by resistance welding, to ensure a sufficient weld strength. Separation of weld joints, or buckling or breakage of strip-like conductive portions when the battery is subjected to an impact is well suppressed, whereby a possible rise in the internal resistance and short circuits are prevented.

Preferably, an edge part of the active material layer which is in parallel with the porous metal layer should cover part of the porous metal layer.

The overall thickness of the strip-like conductive portion and the porous metal layer should preferably be 20 to 100% of the overall thickness of the electrode including the metal substrate and the active material layer.

The positive and negative electrodes should preferably include a bared edge portion of the metal substrate at one end along the winding direction opposite from the conductive portion, which bared edge portion is formed with a porous metal layer coated thereon such as to be flush with the active material layer.

The metal foil should preferably be either one of nickel foil and nickel-plated iron foil and have a thickness of 10 to 60 μm.

The porous metal layer should preferably be a sintered metal layer including at least one metal powder selected from the group consisting of nickel powder, stainless steel powder, chromium powder, and copper powder.

The metal substrate should preferably be one of metal foil having a lath structure, metal foil having a punched structure, and metal sheet having a three-dimensional structure in which bulged strips are formed in rows along one direction and protruded alternately on both sides of the sheet.

The present invention further provides a method for manufacturing a rechargeable battery, including the steps of:

applying a paste containing metal powder and a thickener at least on one side of an edge portion at one end of a metal substrate, and drying and sintering the paste to form a porous metal layer thereon;

applying a paste containing an active material at least on one side of the metal substrate where the porous metal layer has not been formed, and drying the paste to form an active material layer thereon, thereby obtaining an electrode;

forming a wound electrode assembly consisting of a positive electrode, a negative electrode, and a separator interposed therebetween, at least one of the positive and negative electrodes employing the electrode formed through the previous process steps;

welding a current collector to an end face of the positive and/or negative electrode at one end where the porous metal layer has been formed;

accommodating the electrode assembly with the current collector welded thereto into a case together with electrolyte;

connecting the current collector to a sealing member; and

sealing the case with the sealing member.

The porous metal layer is formed on the metal substrate by diffusion welding in which a paste containing metal powder and thickener is sintered. With this method, the porous metal layer can readily be formed on the very thin metal substrate, without presenting any problems entailed in the conventional welding of thin metal plates on the strip-like conductive portions. An overlapping layer of active material is simply formed by coating the active material on the porous metal layer. Thus, the rechargeable battery of the present invention is manufactured with this method with high productivity.

In the step of forming the porous metal layer, the paste may be applied at edge portions at both ends of the metal substrate.

The metal powder should preferably be either one of metal particles having a mean particle diameter of 0.5 to 4.0 μm and metal particles having a chain-like three-dimensional structure. If nickel powder is used, it should preferably have a volume density of 2.0 g/cm³ or more, so as to ensure a high density of the sintered porous metal and a high strength.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 illustrates a longitudinal cross-sectional view of a half of a rechargeable battery according to a first embodiment of the invention;

FIG. 2 is an enlarged view of major parts of FIG. 1;

FIG. 3 is a longitudinal cross-sectional view illustrating major parts of a rechargeable battery according to a second embodiment of the invention; and

FIG. 4 is a longitudinal cross-sectional view illustrating major parts of a rechargeable battery according to a third embodiment of the invention.

### DETAILED DESCRIPTION OF THE PREFERRED EMBODIMENTS

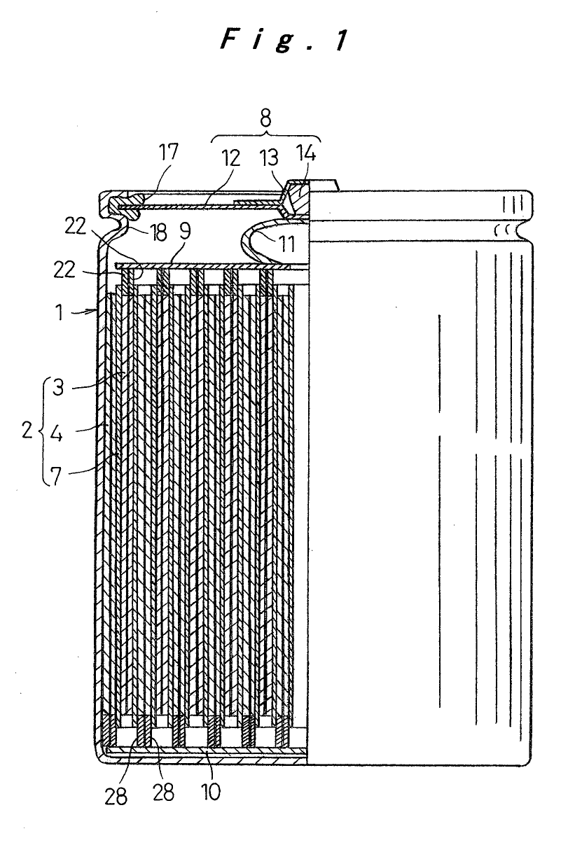

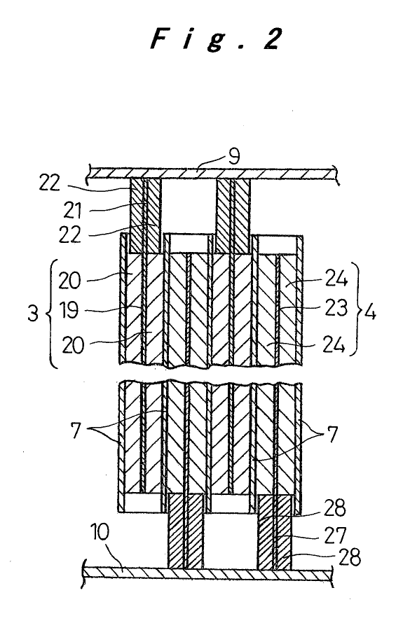

Preferred embodiments of the present invention will be hereinafter described in detail with reference to the accompanying drawings. FIG. 1 is a longitudinal cross-sectional view of a half cut alkaline rechargeable battery according to a first embodiment of the invention. The battery includes a bottomed cylindrical case 1 and a wound electrode assembly 2, housed in the case 1, of a positive electrode 3 and a negative electrode 4 with a separator 7 interposed therebetween. The case 1 is filled with electrolyte (not shown), and the opening of the case is sealed by a sealing member 8. The electrode assembly 2 will be described in more detail later with reference to FIG. 2.

A flat plate positive electrode current collector 9 is welded to the upper end face of the positive electrode 3, and a flat plate negative electrode current collector 10 is welded to the lower end face of the negative electrode 4. The positive electrode current collector 9 is connected to a sealing plate 12 forming the sealing member 8 via a lead plate 11, while the negative electrode current collector 10 is connected by welding to the bottom of the battery case 1.

The sealing member 8 is constructed with the sealing plate 12, a cap terminal 13 welded on top of the sealing plate 12, and a safety vent 14 accommodated in the space formed by the sealing plate 12 and cap terminal 13. The sealing member 8 is placed upon an inwardly bent annular support part 18 of the case 1 with an insulating gasket 17 interposed around the periphery, and the open peripheral edge of the case 1 is swaged inwards to fixedly hold the sealing member 8 between itself and the annular support part 18, thereby sealing the opening of the case 1.

FIG. 2 is an enlarged view of major parts of FIG. 1. The positive electrode 3 includes a metal substrate 19 and active material layers 20 coated on both sides thereof. The positive electrode 3 further includes a strip-like conductive portion 21 formed of a bared edge portion of the metal substrate 19 which is not coated with the active material at one end (upper end in the drawing) in the winding direction (left to right). Porous metal layers 22, which will be described in more detail later, are formed on both sides of this strip-like conductive portion 21.

The negative electrode 4 includes a metal substrate 23 and active material layers 24 coated on both sides thereof. The negative electrode 4 further includes a strip-like conductive portion 27 formed of a bared edge portion of the metal substrate 23 which is not coated with the active material at one end (lower end in the drawing) in the winding direction. Porous metal layers 28, which will be described later, are formed on both sides of this conductive portion 27.

The active material of the positive electrode chiefly comprises nickel hydroxide, and the active material of the negative electrode chiefly comprises an alloy that can absorb hydrogen, or cadmium. The separator 7 is made of a polypropylene or polyethylene unwoven cloth that has undergone hydrophilic treatment such as sulfonation. The electrolyte is a solution of potassium hydroxide.

The metal substrate 19 of the positive electrode is made of metal foil that has a nickel coat on the surface, i.e., nickel foil or nickel-plated iron foil. The thickness of the metal foil is about 10 to 60 μm. If the thickness is smaller than 10 μm, the handling will be too difficult, while, if it is larger than 60 μm, then the metal substrate 19 will take up too much space in the positive electrode 3 and the battery capacity cannot be increased.

The metal foil should preferably have some surface irregularities: it may be formed with sharp protrusions on both sides by needle punching, or processed to be in the form of a lath or expanded metal, or punched with through holes, or it may undergo surface treatment such as etching, metal powder sintering, or plating for surface roughening.

The metal foil thus processed has high active material retaining capability despite the small thickness of 10 to 60 μm, and it allows ions and gas that are generated as a result of chemical reactions in the battery to pass through. The above various processes for the surface roughening are all simple, and so the metal foil can be fabricated at low cost and with high productivity.

The metal substrate 23 of the negative electrode, on the other hand, is a thin punched metal of about 35 μm. This is much thinner than the punched metal that is used for the negative electrode of conventional rechargeable batteries, which is about 60 μm thick. The metal substrate 23 of the negative electrode may be made of metal foil, as with the positive metal substrate 19.

Because the metal substrate 19 of the positive electrode is a 10-60 μm thick metal foil and the metal substrate 23 of the negative electrode is a 35 μm thick punched metal in this embodiment, both metal substrates 19, 23 can be made longer by the decrease in the thickness, and hold more active material than the metal substrates of conventional electrodes. The battery capacity is increased accordingly.

For the metal substrates 19, 23, the aforementioned metal sheet material having a three-dimensional structure with bulged strips alternately protruded on the front and back of the sheet and arranged in parallel rows can also favorably be used. The metal sheet material is more inexpensive than three-dimensional porous metal materials while it exhibits high current collection efficiency because of the three-dimensional structure; it is therefore suited to achieve an increase in the battery output at low cost.

The above rechargeable battery employs tabless current collectors 9, 10 welded to the strip-like conductive portions 21, 27 of the positive and negative electrodes 3, 4, whereby current is collected from the entire electrodes 3, 4; thus the high-rate discharge characteristics of the battery are excellent and the output is increased. Further, a cost reduction is achieved because the two-dimensional metal substrates 19, 23 such as metal foil and punched metal are more inexpensive than conventional foamed nickel plates.

While the metal substrates 19, 23 are extremely thin, their strip-like conductive portions 21, 27 are reinforced by the porous metal layers 22, 28, which are readily formed on the strip-like conductive portions 21, 27 by diffusion welding or other suitable means. The strip-like conductive portions thus have sufficient strength and withstand the pressure when welding metal plates thereto without presenting problems as with the prior art.

Because pressure can be applied sufficiently when welding the current collectors 9, 10 to the strip-like conductive portions 21, 27 by resistance welding, the resultant weld joints will have sufficient strength. Thereby, separation of the weld joints, or buckling or breakage of the strip-like conductive portions 21, 27 when the battery is subjected to an impact during use (e.g., falling off) is prevented, and the risk of a rise of internal resistance or of short-circuiting is much reduced.

The overall thickness of the strip-like conductive portions 21, 27 and porous metal layers 22, 28 should preferably be smaller than the thickness of the positive or negative electrode including the metal substrates 19, 23 and active material layers 20, 24. Thereby, misalignment between the electrodes is prevented when winding them into the electrode assembly 2.

Next, the manufacturing method of the above rechargeable battery is described. First, metal powder is mixed to a solution of thickener to form a paste. The paste may further contain a binder and an antifoaming agent. The metal powder particles should preferably have a 0.5 to 4.0 μm particle diameter, or a chain-like three-dimensional structure. Metal powder with a particle diameter of less than 0.5 μm is very expensive. On the other hand, if the metal powder has a particle diameter of more than 4.0 μm, then the process of sintering the paste will take longer and the productivity will be lowered.

Examples of the thickener include cellulose, cellulose derivatives, and polyvinyl alcohol. The cellulose derivatives include methylcellulose, carboxymethylcellulose (CMC), and hydroxymethylcellulose. The thickener functions also as an adhesive that binds the metal particles to the metal substrates 19, 23.

Next, the paste is applied on the positive electrode substrate 19 consisting of metal foil or processed metal foil and on the negative electrode substrate 23 consisting of punched metal, in the portions that will form the strip-like conductive portions 21, 27, respectively, using a dispenser or a die coat method. The metal sheet coated with the paste may then be dried and/or rolled as required.

The paste is then dried and calcined to sinter the metal powder, whereby porous metal layers 22, 28 are diffusion-welded on the metal substrates 19, 23. The diffusion-welding method thus enables porous metal layers 22, 28 to be readily formed on extremely thin metal substrates 19, 23.

Next, active material layers 20, 24 are formed on the metal substrates 19, 23 where the porous metal layers 22, 28 have not been formed. For the positive electrode 3, a paste containing an active material that chiefly comprises nickel hydroxide and a binder is coated on a predetermined portion of the metal substrate 19, which is then dried, rolled, and cut to obtain electrodes including the portions with porous metal layers 22 of a preset size.

The paste may further include a conductive agent and a thickener. The conductive agent may be, for example, a cobalt compound such as cobalt hydroxide. The thickener may be water-soluble cellulose or acrylic derivatives, or polyvinyl alcohol derivatives.

The active material may be, for example, nickel hydroxide powder with cobalt or zinc in solid solution. The binder may be polytetrafluoroethylene, polyethylene derivatives, or fluorine rubber.

For the negative electrode 4, a paste containing an active material that chiefly comprises an alloy that can absorb hydrogen or cadmium and a binder is coated on a predetermined portion of the metal substrate 23, which is then dried, rolled, and cut to obtain electrodes including the portions with porous metal layers 28 of a preset size.

These positive and negative electrodes 3, 4 are wound around together with the separator 7 interposed therebetween to form the electrode assembly 2. The current collectors 9, 10 are welded to the end faces of the strip-like conductive portion 21 with the porous metal layers 22 of the positive electrode and of the strip-like conductive portion 27 with the porous metal layers 28 of the negative electrode, respectively, by resistance welding.

After the electrode assembly 2 with the current collectors 9, 10 welded thereto is accommodated in the battery case 1, a weld bar is inserted into the center hole of the electrode assembly 2, to weld the negative electrode current collector 10 to the bottom of the case 1 by resistance welding. Electrolyte is then poured into the case 1. The positive electrode current collector 9 is then connected to the sealing plate 12 of the sealing member 8 via the lead plate 11, and the sealing member 8 is inserted into the case 1, with the insulating gasket 17 fitted to its periphery, such as to sit on the annular support part 18. Lastly, the open edge of the case 1 is swaged inwards to fix the sealing member 8 to the case 1, thus tightly sealing the case 1.

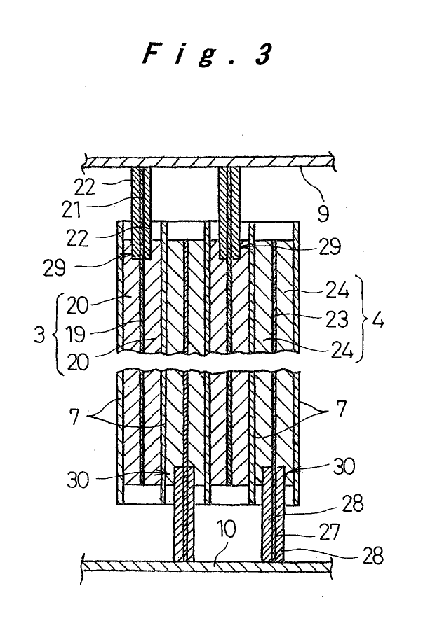

FIG. 3 is a longitudinal cross-sectional view illustrating major parts of a rechargeable battery according to a second embodiment of the invention. The elements in the drawing that are identical or similar to those of FIG. 2 are given the same reference numerals, and the repetitive description thereof will be omitted. This battery differs from that of the first embodiment in that the parts of the porous metal layers 22, 28 adjoining the active material layers 20, 24 are covered by the active material layers.

The overlapping layers 29, 30 of the porous metal layers 22, 28 and active material layers 20, 24 should preferably be in the range of 0.2 to 1 mm, and more preferably 0.2 to 0.5 mm. Because of the provision of the overlapping layers 29, 30, the porous metal layers 22, 28 need to be thinner as compared to the case with the first embodiment. The overall thickness of the strip-like conductive portions 21, 27 and porous metal layers 22, 28 should preferably be 20 to 50% relative to the thickness of the positive or negative electrode including the metal substrates 19, 23 and active material layers 20, 24. Thereby, misalignment between the electrodes when forming the electrode assembly 2 is prevented.

With this rechargeable battery, the same effects as with the first embodiment are achieved, and in addition, the interface between the active material layers 20, 24 and strip-like conductive portions 21, 27 of the metal substrates 19, 23, which is the weakest part and most susceptible to the impact applied to the battery, are reinforced by the provision of the overlapping layers 29, 30 and given sufficient strength. Therefore, buckling or breakage of the strip-like conductive portions 21, 27 or short-circuiting in the event of a falling accident is reliably prevented, and an unwanted rise in the internal resistance is prevented. Furthermore, because the active material is prevented from coming off at the edge of the layers 20, 24, the battery performance is maintained over a long time.

This rechargeable battery is fabricated through the similar process steps as those of the first embodiment, except that the porous metal layers 22, 28 are formed on the metal substrates 19, 23 to a smaller thickness than the case with the first embodiment, and that the active material paste is coated so as to overlap part of the porous metal layers 22, 28. The active material paste is then dried and sintered, whereby the overlapping layers 29, 30 are formed with ease.

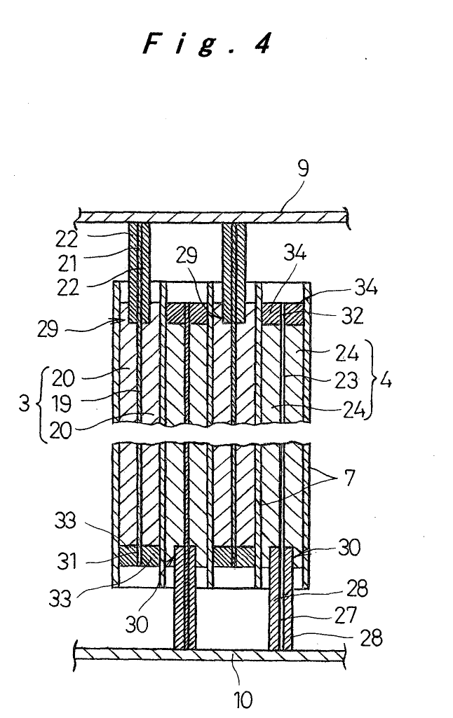

FIG. 4 is a longitudinal cross-sectional view illustrating major parts of a rechargeable battery according to a third embodiment of the invention. The elements in the drawing that are identical or similar to those of FIG. 3 are given the same reference numerals, and the repetitive description thereof will be omitted. This battery differs from that of the second embodiment in that both electrodes are provided with bared edge portions 31, 32 of the metal substrates 19, 23 at the opposite end from the strip-like conductive portions 21, 27, and porous metal layers 33, 34 are formed on both sides of these bared edge portions 31, 32 such as to be flush with the active material layers 20, 24. The porous metal layers 33, 34 are made of the same material as the porous metal layers 22, 28 and formed by the same method.

With this rechargeable battery, the same effects as with the second embodiment are achieved, and in addition, the active material is prevented from coming off in a more reliable manner by the provision of the additional porous metal layers 33, 34 formed flush with the active material layers 20, 24. Because the active material layers 20, 24 expand slightly by repeated charge and discharge of the battery, there is the possibility that part of the active material may come off. The active material that has come off from the layers 20, 24 may contact the current collector 9 or 10 of the opposite polarity and cause short-circuiting.

The porous metal layers 33, 34 are made of the same material as the porous metal layers 22, 28 and can be formed at the same time, and so the overall cost of this battery is almost the same as that of the second embodiment.

### EXAMPLES

Rechargeable batteries according to the present invention were actually fabricated and their performance tested. The following is a description of these examples and the performance evaluation.

(Preparation of Metal Substrate for the Positive Electrode)

The metal substrate for the positive electrode was prepared in the following manner: A 170 g/m² pure nickel foil of 20 μm thickness was obtained by an electroplating process, and 2 mm long slits were formed in this foil with an interval of 0.5 mm in parallel rows extending orthogonally to the direction in which the electrode would be wound. The strips between each two adjacent slits were protruded alternately in opposite directions, so that the foil had a three-dimensional structure with the bulging portions alternately protruding to opposite sides. The distance between the tips of the adjacent bulging portions was 500 μm. A paste containing carbonyl nickel powder (Type 255 manufactured by INCO Ltd.) and a methylcellulose solution (Metolose SM400 manufactured by Shin-Etsu Chemical Co., Ltd.) was coated on both sides of the three-dimensional foil in an amount of 50 g/m² and dried, to complete the metal substrate for the positive electrode.

(Preparation of Strip-Like Conductive Portion for the Positive Electrode)

A paste containing nickel metal powder (Type CGNP manufactured by INCO Ltd.) and a methylcellulose solution (SM400) was coated on the metal substrate for the positive electrode in the portion that would form the strip-like conductive portion, in a width of 0.5 mm and to such a thickness that the thickness including the metal substrate after the sintering would be 200 μm, using a dispenser. The paste was dried, and then sintered in a reduced environment containing steam, hydrogen, and nitrogen at a temperature of 950° C. for 15 minutes, to form the strip-like conductive portion for the positive electrode according to the first embodiment (example 1).

Strip-like conductive portion according to the second or third embodiment was formed as follows: A paste containing nickel metal powder (CGNP) and a methylcellulose solution (SM400) was coated on the metal substrate in the portion that would form the strip-like conductive portion, in a width of 1.5 mm and to such a thickness that the thickness after the sintering would be 200 μm, using a dispenser. The paste was dried, and then sintered in a reduced environment containing steam, hydrogen, and nitrogen at a temperature of 950° C. for 15 minutes. The strip-like conductive portion took up 1 mm of the 1.5 mm width, while the remaining 0.5 mm portion would be the overlapping layer.

(Fabrication of Positive Electrodes)

Solid solution particles of nickel hydroxide, fine particles of cobalt hydroxide, a CMC solution (with a solids concentration of 1 part by weight), and a fluorine rubber dispersant (AFLAS™ 150 manufactured by Asahi Glass Co., Ltd.) were mixed so that the solids ratio would be 4% by weight, to obtain active material paste for the positive electrode. The paste was coated on the metal substrate except for the strip-like conductive portion using a die, and then dried with hot air of 100° C. blown for 10 minutes. The dried electrode was rolled to a thickness of 400 μm using a roll press, and cut into rectangular pieces of 375 mm length and 35 mm width, to obtain the positive electrodes (example 1). The positive electrode included a 1 mm wide strip-like conductive portion at one edge, and a 0.5 mm wide part of the porous metal layers formed on this conductive portion was a sintered layer, while the other 0.5 mm wide part thereof was a non-sintered layer.

The positive electrode for example 2 was likewise prepared; the active material paste was obtained by mixing solid solution particles of nickel hydroxide, fine particles of cobalt hydroxide, a CMC solution (with a solids concentration of 1 part by weight), and a fluorine rubber dispersant (AFLAS™ 150), with the solids ratio of 4% by weight. The paste was coated on the metal substrate such that the paste layer overlapped a 0.5 mm wide part of the porous metal layers on the strip-like conductive portion, using a die, and then dried with hot air of 100° C. blown for 10 minutes. The dried electrode was rolled to a thickness of 400 μm using a roll press, and cut into rectangular pieces of 375 mm length and 35 mm width, to obtain the positive electrodes.

(Fabrication of Rechargeable Batteries)

The positive electrodes of the examples 1 and 2 were respectively wound with a negative electrode, which was nickel-plated iron foil of 60 μm thickness coated with an active material chiefly comprising an alloy that can absorb hydrogen, and a separator made of polypropylene that had undergone hydrophilic treatment, to form electrode assemblies. After welding a current collector to the strip-like conductive portion of the positive electrode by resistance welding, the electrode assembly was accommodated into the case of a SC size battery. Electrolyte chiefly comprising 8N potassium hydroxide was poured into the case, and the opening of the case was sealed with the sealing member. The cylindrical nickel metal hydride rechargeable batteries of the examples 1 and 2 thus obtained had a nominal capacity of 3300 mAh.

### Comparative Example 1

The rechargeable battery of the comparative example 1 uses a metal foil without the porous metal layers for the metal substrate of the positive electrode. The other features are the same as those of the example 1.

### Comparative Example 2

The rechargeable battery of the comparative example 2 uses a metal foil without the porous metal layers for the metal substrate of the positive electrode, and a nickel lead of 0.8 mm width, 60 μm thickness was welded onto the entire conductive portion of the metal substrate. The other features are the same as those of the example 1.

### Comparative Example 3

The rechargeable battery of the comparative example 3 uses the same metal substrate of the positive electrode as the comparative example 1, except that, after the electrodes were wound into the assembly, the strip-like conductive portion of the metal substrate of the positive electrode was bent inwards and flattened using a press machine, and the current collector was welded to the flattened conductive portion of the positive electrode by laser welding. The other features are the same as those of the example 1.

(Determination of the Weld Strength of the Current Collectors)

At the stage when the electrodes of examples 1, 2 and comparative examples 1 to 3 were formed into electrode assemblies, a current collector having a tab formed by a burring process was welded to the conductive portion of the positive electrode with a predetermined voltage and pressure being applied. After that, a tension test was conducted with respect to the tab on the current collector at a preset speed to determine the weld strength between the current collector and the strip-like conductive portion of the positive electrode, using a push pull gauge. The results are shown in Table 1.

TABLE 1

| | Ex- | Ex- | | | |
|---|---|---|---|---|---|
| | ample | ample | Comparative | Comparative | Comparative |
| | 1 | 2 | example 1 | example 2 | example 3 |
| Weld | 9 N | 9 N | 2 N | 9 N | 6 N |
| Strength | | | | | |

The results showed that the weld strength between the current collector and the strip-like conductive portion of the positive electrode was higher in the examples 1, 2 than in the comparative examples 1, 3. The weld strength was high in the comparative example 2, too, because of the lead welded to the conductive portion of the electrode. In the comparative example 3, while the weld area was large, the conductive portion was deteriorated by the heat of laser, resulting in the low weld strength.

(Evaluation of Shock Resistance of the Batteries)

Ten each of rechargeable batteries of the examples 1, 2 and comparative examples 1 to 3 were dropped from a height of 75 cm onto a concrete surface three times as one cycle, first in the normal orientation, then upside down, and in the lateral orientation, to determine the change in the internal resistance per one cycle and the short circuit occurrence rate. Table 2 shows the average numbers of cycles until the internal resistance rose 10 mΩ from the initial value, and the short circuit failure rate in the same shock resistance test with respect to the ten each of rechargeable batteries. Note that the numbers of cycles were counted only with respect to the rechargeable batteries in which no short-circuiting occurred.

TABLE 2

| | Ex- | Ex- | | | |
|---|---|---|---|---|---|
| | ample | ample | Comparative | Comparative | Comparative |
| | 1 | 2 | example 1 | example 2 | example 3 |
| Short | 3/10 | 0/10 | 3/10 | 3/10 | 2/10 |
| circuit | | | | | |
| failure | | | | | |
| rate | | | | | |
| Number of | 50 | 70 | 5 | 50 | 20 |
| cycles | | | | | |

As is seen from Table 2, the battery of the example 1 showed good results in suppressing a rise in the internal pressure in the shock resistance test as compared to the batteries of the comparative examples 1, 3. This is because separation of the current collectors from the strip-like conductive portions was suppressed because of the much improved weld strength therebetween.

The rechargeable battery of the example 2 showed excellent results in the short circuit failure rate in the shock resistance test as compared to the batteries of the comparative examples 1 to 3. This is because buckling of the strip-like conductive portions was suppressed because of the improved strength in the interface between the strip-like conductive portions and active material layers.

(Evaluation of Batteries)

After conducting two initial charge and discharge cycles to the batteries of the examples and comparative examples, they were aged at 45° C. for three days (to activate the alloy in the negative electrodes by heat). The batteries were charged at a rate of 0.1C for 15 hours and discharged at 0.2C for four hours in one cycle. After that, the batteries were charged and discharged under four different conditions, to evaluate the utilization rate of positive electrode. They were all charged at 0.2C for 7.5 hours and let stand for half an hour, after which they were discharged at 1C, 10A, 20A, and 30A, until the voltage was 0.8V. The results are shown in Table 3.

TABLE 3

| | Utilization | Utilization | Utilization | Utilization |
|---|---|---|---|---|
| | rate at | rate at | rate at | rate at |
| | discharge | discharge | discharge | discharge |
| | current of | current of | current of | current of |
| Battery type | 1C | 10A | 20A | 30A |
| Example 1 | 98 | 93 | 91 | 89 |
| Example 2 | 98 | 93 | 91 | 89 |
| Comparative | 98 | 90 | 88 | 86 |
| example 1 | | | | |
| Comparative | 98 | 93 | 91 | 89 |
| example 2 | | | | |
| Comparative | 98 | 90 | 88 | 86 |
| example 3 | | | | |

The utilization rate of positive electrode was obtained by dividing the discharge capacity (capacity up to a battery voltage of 0.8V) by the theoretical capacity of positive electrode (the weight of nickel hydroxide in the positive electrode active material multiplied by a capacity of 289 mAh/g, provided that nickel hydroxide underwent one-electron reaction).

As is seen from Table 3, the batteries of the examples 1, 2 and comparative example 2 exhibited high utilization rate of positive electrode as compared to the batteries of the comparative examples 1, 3. This is because the component resistance between the strip-like conductive portions and current collectors was reduced in the batteries of the examples due to the improved current collecting structure, whereby the discharge characteristics were improved.

As described above, the battery according to the present invention uses thin metal foil for the metal substrate of at least one of the positive and negative electrodes, whereby the electrode is made longer and carries more active material, to increase the battery capacity. The current collectors are a tabless type, whereby the high-rate discharge characteristics of the battery are excellent and the output is increased. The two-dimensional metal foil for the substrate is inexpensive, and a cost reduction is achieved. The strip-like conductive portions made of the thin metal substrate are reinforced by the porous metal layers, which are readily formed by diffusion welding or other suitable means, so that pressure can be applied sufficiently when welding the current collectors to the strip-like conductive portions by resistance welding, to ensure a sufficient weld strength. Separation of weld joints, or buckling or breakage of strip-like conductive portions when the battery is subjected to an impact is well suppressed, whereby a possible rise in the internal resistance and short circuits are prevented.

With the method for manufacturing the rechargeable battery according to the present invention, the porous metal layers are formed on the metal substrate by diffusion welding in which a paste containing metal powder and thickener is sintered. With this method, the porous metal layers are readily formed on the very thin metal substrate. The overlapping layer is simply formed by coating the active material on the porous metal layers.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A rechargeable battery, comprising:
a wound assembly of a positive electrode, a negative electrode, and a separator interposed therebetween, accommodated in a case together with electrolyte, the positive and negative electrodes being respectively formed of a metal substrate and an active material layer coated thereon and including a strip-like conductive portion at one end along a direction in which they are wound, said strip-like conductive portion being formed of a bared edge portion of said metal substrate, and current collectors being respectively welded to said strip-like conductive portions of the electrodes, wherein
the metal substrate of at least one of said positive electrode and negative electrode is made of metal foil, and said strip-like conductive portion of one of said positive and negative electrodes that uses metal foil is formed with a porous metal layer at least on one side thereof.

2. The rechargeable battery according to claim 1, wherein an edge part of said active material layer covers part of said porous metal layer.

3. The rechargeable battery according to claim 1, wherein said strip-like conductive portion and said porous metal layer together have a thickness that is 20 to 100% of the overall thickness of the electrode including the metal substrate and the active material layer.

4. The rechargeable battery according to claim 1, wherein the positive and negative electrodes include a bared edge portion of the metal substrate at one end along the winding direction opposite from said strip-like conductive portion, and said bared edge portion is formed with a porous metal layer coated thereon such as to be flush with said active material layer.

5. The rechargeable battery according to claim 1, wherein the metal foil is either one of nickel foil and nickel-plated iron foil and has a thickness of 10 to 60 μm.

6. The rechargeable battery according to claim 1, wherein the porous metal layer is a sintered metal layer including at least one metal powder selected from the group consisting of nickel powder, stainless steel powder, chromium powder, and copper powder.

7. The rechargeable battery according to claim 1, wherein the metal substrate is one of metal foil having a lath structure, metal foil having a punched structure, and metal sheet having a three-dimensional structure in which bulged strips are formed in rows along one direction and protruded alternately on both sides of the sheet.

8. A method for manufacturing a rechargeable battery, comprising:
applying a paste containing metal powder and a thickener at least on one side of an edge portion at one end of a metal substrate, and drying and sintering said paste to form a porous metal layer thereon;
applying a paste containing an active material at least on one side of said metal substrate where said porous metal layer has not been formed, and drying said paste to form an active material layer thereon, thereby obtaining an electrode;
forming a wound assembly of electrodes consisting of a positive electrode, a negative electrode, and a separator interposed therebetween, at least one of said positive and negative electrodes being formed through the previous process steps;
welding a current collector to an end face of said positive and/or negative electrode at one end where said porous metal layer has been formed;
accommodating said electrode assembly with said current collector welded thereto into a case together with electrolyte;
connecting said current collector to a sealing member; and
sealing said case with said sealing member.

9. The method for manufacturing a rechargeable battery according to claim 8, wherein, in the step of forming said porous metal layer, said paste is applied at edge portions at both ends of said metal substrate.

10. The method for manufacturing a rechargeable battery according to claim 8, wherein said metal powder is either one of metal particles having a mean particle diameter of 0.5 to 4.0 μm and metal particles having a chain-like three-dimensional structure.
